(19) United States
(12) Patent Application Publication
(10) Pub. No.: US 2004/0121138 A1
(43) Pub. Date: Jun. 24, 2004

(54) Composite panel

(76) Inventor: Thomas A. Carstensen, Shelton, CT (US)

Correspondence Address: BACHMAN & LAPOINTE, P.C., 900 CHAPEL STREET, SUITE 1201, NEW HAVEN, CT, 06510, US

(21) Appl. No.: 10/325,238

(22) Filed: Dec. 20, 2002

(51) Int. Cl. B32B 3/26; B32B 5/24; D21H 11/00; D21H 13/00

(52) U.S. Cl. 428/304.4; 428/311.11; 428/311.51

(57) ABSTRACT

A composite material has a foam core having first and second faces. A plurality of fibrous pins have first end portions protruding from the core first face. A first face sheet is secured to the core first face. The first face sheet comprises, in major part, one or more non-woven, non random, fiber layers. The pin first end portions protrude into the first face sheet.

### U.S. GOVERNMENT RIGHTS

The invention was made with U.S. Government support under contract DAAH10-98-2-0001 awarded by the U.S. Army. The U.S. Government has certain rights in the invention.

### (1) FIELD OF THE INVENTION

The invention relates to composite materials. More particularly, the invention relates to composite panels for aircraft fuselage use.

### (2) DESCRIPTION OF THE RELATED ART

Composite materials are well known in aircraft fuselage construction. A common construction involves a panel formed of a lightweight core with a pair of high strength facesheets on respective faces of the core. One exemplary construction involves facesheets formed of a resin preimpregnated (prepreg) fabric secured to a honeycomb core. This material has been observed to suffer from severe crack propagation associated with ballistic impact. Such crack propagation may contribute to structural failures.

One recent improvement in facesheet technology has been the adoption of so-called “fiber placed” facesheets. In an exemplary fiber placed process a prepreg fiber bundle (e.g., a circular-sectioned tow or flattened tape) is applied to a tool, the surface of which defines the shape of the panel as would a mold. The application permits control of fiber direction in response to a desired strength characteristic. Individual plies within a facesheet may have different directions. The application is advantageously performed by a numerically-controlled, preprogrammed machine to provide precision, speed and repeatability, although hand lay-up is possible.

Separately, improvements have been made to foam core technology. One particular advance has been the use of foam preforms reinforced with fiber pins. In this product, the pins are inserted through the foam in an array of individual pins and/or groups of pins. For example, there may be a square array of groups of four pins, each pin within the group extending through the core in a different direction than the other pins, all non-perpendicular to the core surfaces. Exemplary pins are pultruded rods of fiber (e.g., carbon T300 1K) and resin (e.g., epoxy) matrix. The pins protrude from each face of the core so as to penetrate the fabric facesheets upon lamination to provide an enhanced mechanical bond between the core and the facesheets. Such a product is sold by Aztex Inc. of Waltham, Mass. under the trademark X-COR.

### BRIEF SUMMARY OF THE INVENTION

Accordingly, one aspect of the invention is a composite material with a foam core having first and second faces. A plurality of fibrous pins have first end portions protruding from the core first face. A first face sheet is secured to the core first face. The first face sheet comprises, in major part, one or more non-woven, non-random, fiber layers. The pin first end portions protrude into the first face sheet.

The material may have a second face sheet secured to the core second face. The pins may have second end portions protruding from the core second face into the second facesheet. The material may advantageously be utilized as an aircraft fuselage panel.

Other aspects of the invention may involve methods for manufacturing a panel. An electronically-controlled machine may be utilized to lay a non-woven, non-random first fiber layer on a first face of the mold, leaving a first face of the layer exposed. A foam core material may be positioned in proximity to the first face of the first layer. The foam core material may have a core first face and an opposite core second face and may have a plurality of pins extending through the core foam. Each pin may have first and second ends respectively protruding from the core first and second faces. A first face of a second fiber layer is positioned proximate the core second face. The assembled core and fiber layers are compressed against the mold so as to cause the first and second pin ends to respectively penetrate into the first and second fiber layers. The assembled core and fiber layers may then be cured.

### BRIEF DESCRIPTION OF THE DRAWINGS

FIG. 1 is a partial semi-schematic cross sectional view of a composite panel.

FIG. 2 is a schematic cross-sectional view of a panel in a manufacturing tool.

Like reference numbers and designations in the various drawings indicate like elements.

### DETAILED DESCRIPTION

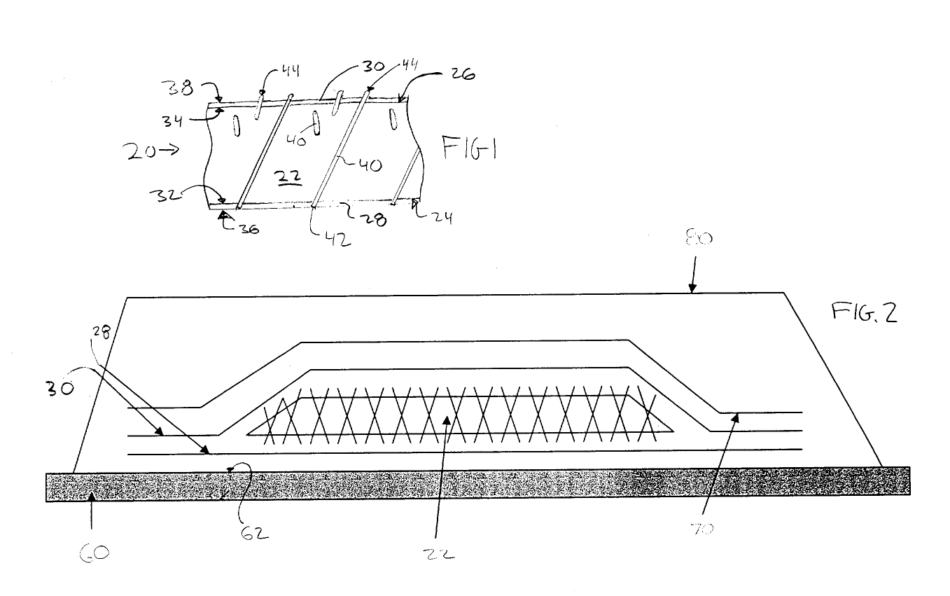

FIG. 1 shows a composite panel 20 having a foam core 22 having first and second faces 24 and 26. First and second fiber placed facesheets 28 and 30 are secured to the first and second faces and have respective inboard (i.e., facing the core) faces 32 and 34 and outboard faces 36 and 38.

Pins 40 extend through the core. The pins have first and second ends 42 and 44 protruding beyond the core first and second faces. A first end portion of each pin is substantially embedded in the first facesheet with the first end 42 substantially flush to the outboard face 36. The second end portion of each pin protrudes through the second facesheet with its end 44 slightly beyond the outboard face 38. A resinous matrix secures the pins to the facesheets and the facesheets to the core.

Compared with similar fiber-placed honeycomb core panels, the use of the pin-reinforced foam core has been shown to substantially reduced crack propagation associated with ballistic impact (e.g., bullet penetration).

FIG. 2 shows a tool 60 having a first face 62, the shape of which forms a negative of a desired exterior panel shape as in a mold. To manufacture the panel, the first facesheet 28 is applied to the surface 62. This is advantageously performed utilizing an electronically controlled machine (not shown) to lay a tow or tape of unidirectional fibers. The orientation of the fiber laying is in accordance with desired structural properties of the panel. The application process may provide multiple plies of different orientations. This application leaves the inboard face of the facesheet exposed. The core 22 is then positioned in proximity to the inboard face of the first facesheet. At this point, the pins protrude from both first and second faces of the core. The second facesheet 30 may then be positioned atop the core in a similar fashion as the first facesheet was applied to the tool. An elastomeric caul plate 70 is then positioned atop the second facesheet and a vacuum bag 80 applied over the assembly. The vacuum bag 80 is evacuated and compresses the core and first and second facesheets between the tool and caul plate. During this process, respective first and second ends of the pins penetrate the first and second facesheets. Penetration substantially beyond the outboard face of the first facesheet 28 is prevented by the tool. Accordingly, the pins may tend to be driven, from their initial positions, through the core toward the second facesheet so as to fully penetrate the second facesheet and protrude from its outboard surface. The protruding pins can become embedded in the caul plate. The assembled core and facesheets may then be cured. The vacuum bag may be removed. The caul plate may be removed from the second facesheet and the panel may be removed from the tool.

One or more embodiments of the present invention have been described. Nevertheless, it will be understood that various modifications may be made without departing from the scope of the invention. For example, any particular application may dictate or influence features of the panel. Various materials may be used before the facesheets, foam, and pins. Alternate pin materials include fiberglass, quartz, aramid fiber, titanium, and stainless steel. Alternate skin materials include fiberglass, aramid fiber, nylon, and polypropylene. Accordingly, other embodiments are within the scope of the following claims.

What is claimed is:

1. A composite material comprising:
a foam core having first and second faces;
a plurality of fibrous pins having first end portions protruding from the core first face; and
a first facesheet secured to the core first face and comprising in, major part, at least one non-woven, non-random, fiber layer with said pin first end portions protruding into said layers.

2. The material of claim 1, wherein said pins have second end portions protruding from said core second face and wherein the material further comprises a second facesheet secured to said second face.

3. The material of claim 1, wherein the pins are pultruded rods comprising carbon fiber and a resin matrix.

4. The material of claim 1, wherein the first facesheet comprises a multi-ply material.

5. The material of claim 1, wherein the first facesheet fibers are selected from the group consisting of carbon fiber, fiberglass, aramid fiber, nylon, and polypropylene.

6. The material of claim 1, utilized as an aircraft fuselage panel.

7. A method for manufacturing a panel, comprising:
utilizing an electronically-controlled machine to lay a non-woven, non-random first fiber layer on a first face of a mold leaving a first face of the layer exposed;
positioning a foam core material in proximity to said first face of said first layer, said foam core material having a core first face and core second face opposite said core first face and having a plurality of pins extending through the core, each pin having first and second ends respectively protruding from said core first and second faces;
positioning a first face of a second fiber layer proximate said core second face;
compressing the assembled core and first and second fiber layers against the mold so as to cause the first and second pin ends to respectively penetrate into the first and second fiber layers; and
curing the assembled core and first and second fiber layers.

8. The method claim 7, wherein the first and second fiber layers are resin pre-impregnated.

9. The method of claim 7, wherein the fibers of the first and second fiber layers are applied from a fiber tow or tape.

10. A composite material comprising:
a foam core having first and second faces;
first and second facesheets secured to said first and second faces and consisting in major part of non-woven, non-random fibers; and
means for impeding crack propagation through said first and second layers due to ballistic impact.

11. The material of claim 10, wherein the means comprises a non-randomly arrayed plurality of pins extending through the core and having respective first and second end portions respectively embedded in the first and second facesheets.

12. The material of claim 11, wherein the pins are locally non-perpendicular to the first and second facesheets.
